(19) United States
(12) Patent Application Publication
(10) Pub. No.: US 2024/0097482 A1
(43) Pub. Date: Mar. 21, 2024

(54) SOLAR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/214,163

(22) Filed: Jun. 26, 2023

(30) Foreign Application Priority Data
Sep. 21, 2022 (JP) 2022-150380

(51) Int. Cl. H02J 7/35; B60L 53/51; B60R 16/033

(52) U.S. Cl. CPC H02J 7/35; B60L 53/51; B60R 16/033; B60L 2210/10; H02J 2207/20

(57) ABSTRACT

A solar charging system mounted on a vehicle, comprising: a power generation module using a solar panel; an auxiliary battery storing electric power generated by the power generation module; a driving battery used for driving the vehicle; and a control unit provided between the driving battery and the auxiliary battery and controlling power transfer between both batteries, wherein the control unit changes an amount of electric power of the auxiliary battery transferred to the driving battery based on a state of the vehicle when performing a process of transferring electric power from the auxiliary battery to the driving battery.

### CROSS-REFERENCE TO RELATED APPLICATION

This application claims priority to Japanese Patent Application No. 2022-150380 filed on Sep. 21, 2022 incorporated herein by reference in its entirety.

### BACKGROUND

### 1. Technical Field

The present disclosure relates to a solar charging system that controls supply of power generated by a solar panel mounted on a vehicle.

### 2. Description of Related Art

Japanese Unexamined Patent Application Publication No. 2021-083248 (JP 2021-083248 A) discloses a solar charging system in which, when a solar panel is in a state in which power can be generated, first, power is supplied from the solar panel to an auxiliary system to derive power to be actually generated by the solar panel, and when the generated power that has been derived is equal to or more than a specified value capable of efficiently charging power to the auxiliary system, a driving battery is charged by the generated power of the solar panel.

### SUMMARY

In order to efficiently use power generated by a solar panel and power stored in an auxiliary battery, power may be transferred from the auxiliary battery to a driving battery in a vehicle. On the other hand, in a situation where solar power generation cannot be expected, such as when the vehicle is stored for a long period of time at night or in a state without solar radiation, power is transferred from the driving battery to the auxiliary battery in order to suppress the auxiliary battery from running out due to dark current.

However, such an action of power transfer between the auxiliary battery and the driving battery causes a deterioration in energy efficiency due to power loss caused by a buck-boost operation of a direct current-direct current (DC-DC) converter, and deterioration in the component life such as a relay and an electronic control unit (ECU) related to the power transfer. Therefore, there is room for further study on a method of performing the power transfer between the auxiliary battery and the driving battery.

The present disclosure has been made in view of the above issue, and an object of the present disclosure is to provide a solar charging system capable of improving the energy efficiency in the vehicle and suppressing the deterioration in the component life.

In order to solve the above issue, an aspect of the disclosed technique is a solar charging system mounted on a vehicle, and the solar charging system includes:
a power generation module using a solar panel;
an auxiliary battery for storing power generated by the power generation module;
a driving battery used for driving the vehicle; and
a control unit that is provided between the driving battery and the auxiliary battery and that controls power transfer between the driving battery and the auxiliary battery, in which when a process of transferring power from the auxiliary battery to the driving battery is performed, the control unit changes an amount of power of the auxiliary battery to be transferred to the driving battery based on a state of the vehicle.

With the solar charging system according to the present disclosure, when the power is transferred from the auxiliary battery to the driving battery, the remaining power of the auxiliary battery is changed based on the state of the vehicle. Therefore, when the remaining power of the auxiliary battery is increased, the amount of the power transferred to the driving battery is reduced, so that the power transferred to the auxiliary battery again is suppressed. Therefore, the energy efficiency is improved, and the deterioration in the component life is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a solar charging system according to an embodiment of the present disclosure;

FIG. 2 is a processing flowchart of charge control at the time of power transfer executed by the solar charging system;

FIG. 3 is a diagram for explaining a state of charge of an auxiliary battery;

FIG. 4 is a diagram illustrating an example of a power transfer path (from the auxiliary battery to a driving battery);

FIG. 5 is a diagram illustrating an example of a power transfer path (from the driving battery to the auxiliary battery);

### DETAILED DESCRIPTION OF EMBODIMENTS

In the solar charging system according to the present disclosure, when the electric power is transferred from the auxiliary battery to the driving battery, the remaining electric power of the auxiliary battery is increased to reduce the electric power transferred from the auxiliary battery to the driving battery in a vehicle state in which the amount of solar radiation is unlikely, such as at night or in a garage. Accordingly, it is possible to suppress the power drawn from the driving battery to the auxiliary battery in order to prevent the auxiliary battery from rising.

Hereinafter, an embodiment of the present disclosure will be described in detail with reference to the drawings.

### EMBODIMENT

### Configuration

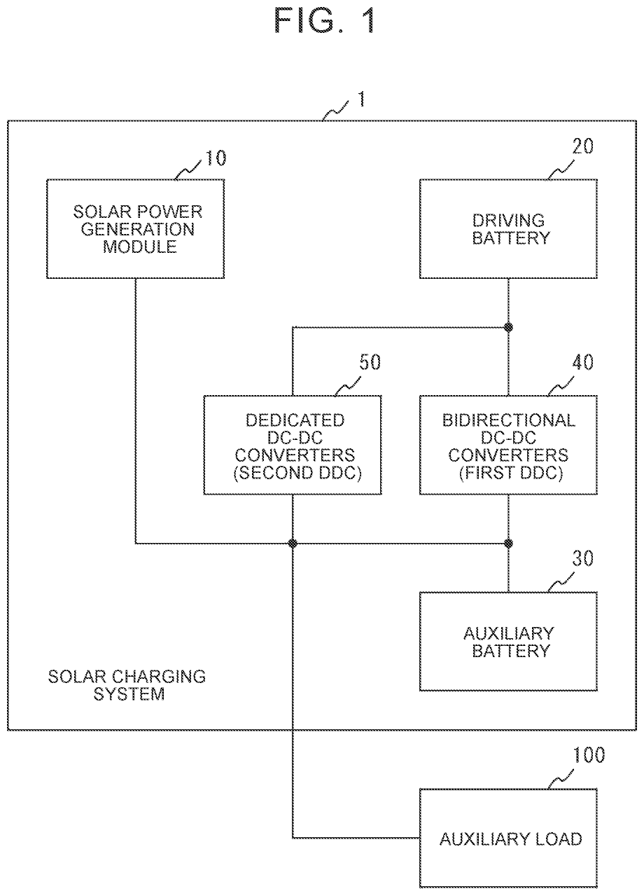

FIG. 1 is a block diagram illustrating a schematic configuration of a solar charging system 1 according to an embodiment of the present disclosure. The solar charging system 1 illustrated in FIG. 1 includes a solar power generation module 10, a driving battery 20, an auxiliary battery 30, a bidirectional DC-DC converter 40, and a dedicated DC-DC converter 50. The solar charging system 1 is mounted on vehicles such as hybrid electric vehicle (HEV), plug-in hybrid electric vehicle (PHEV) and battery electric vehicle (BEV).

The solar power generation module 10 is a power generation device that generates electric power by being irradiated with solar light, and outputs the generated electric power to the auxiliary battery 30, the auxiliary load 100, and the like connected to the solar power generation module 10. The solar power generation module 10 includes a solar panel that is an aggregate of solar cells, a solar DC-DC converter that outputs electric power generated by the solar panel at a predetermined voltage, a solar control unit that performs maximum-power-point tracking (MPPT) control, and the like (not shown). The generated electric power of the solar panel is calculated from a measured value of a sensor or a measuring instrument (not shown).

The driving battery 20 is a secondary battery configured to be chargeable and dischargeable, such as a lithium-ion battery or a nickel-metal hydride battery. The driving battery 20 is connected to a main device (not shown) for driving the vehicle, and can supply power necessary for the operation of the main device. Examples of the main equipment include a starter motor and a traveling electric motor. Further, the driving battery 20 is connected to the solar power generation module 10 via the bidirectional DC-DC converters 40 so as to be able to be charged by electric power generated in the solar panel. Further, the driving battery 20 is connected to the auxiliary battery 30 via the dedicated DC-DC converters 50 so that the auxiliary battery 30 can be charged by the electric power stored therein during parking of the vehicle or the like. The driving battery 20 is a high-voltage battery having a higher rated voltage than the auxiliary battery 30.

The auxiliary battery 30 is a secondary battery configured to be chargeable and dischargeable, such as a lithium-ion battery or a lead-acid battery. The auxiliary battery 30 can supply power necessary for the operation of the auxiliary load 100 to the auxiliary load 100. The auxiliary battery 30 is connected to the solar power generation module 10 so as to be able to be charged by electric power generated in the solar panel. Further, the auxiliary battery 30 is connected to the bidirectional DC-DC converters 40 so as to be able to be charged by electric power stored in the driving battery 20. Further, the auxiliary battery is connected to the driving battery 20 via the dedicated DC-DC converters 50 so as to be capable of supplying electric power from the driving battery 20 in order to avoid the battery rising when the dark current is flowing to the auxiliary load 100 during parking of the vehicle or the like. Note that the amount of charge (storage amount) of the auxiliary battery 30 is monitored by a sensor, a measuring instrument, or the like (not shown).

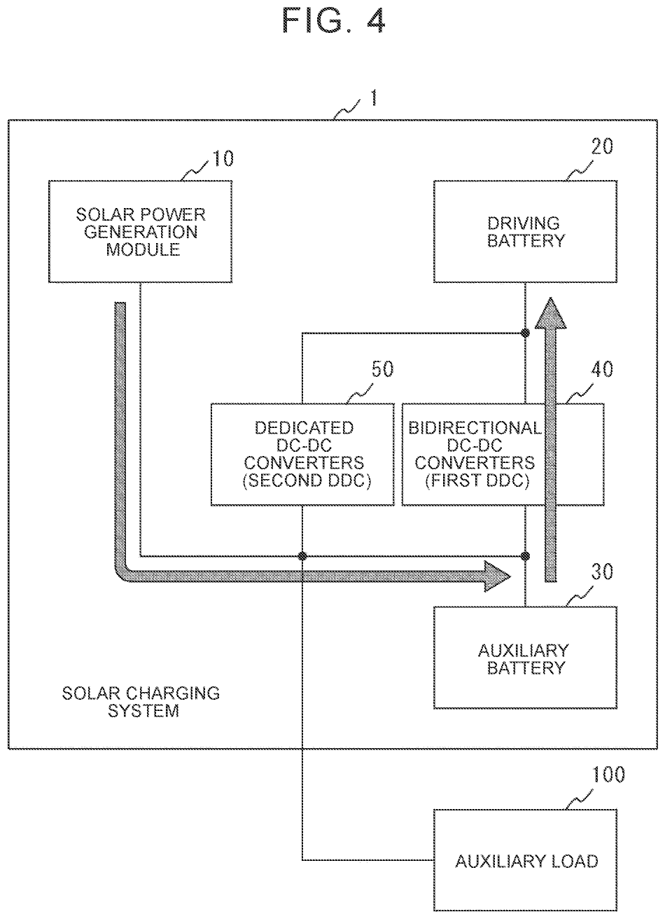

The bidirectional DC-DC converter 40 is a bidirectional power converter (first DC-DC converter) capable of converting the inputted power into a predetermined-voltage power and outputting the converted power. The bidirectional DC-DC converters 40 have one end (referred to as the primary side) connected to the solar power generation module 10, the auxiliary battery 30, and the auxiliary loads 100, and the other end (referred to as the secondary side) connected to the driving battery 20. The bidirectional DC-DC converters 40 can supply (pump-charge) the electric power of the auxiliary battery 30 connected to the primary side to the driving battery 20 connected to the secondary side. FIG. 4 shows an example of a power transfer path when the auxiliary battery 30 is supplied to the driving battery 20. In addition, the bidirectional DC-DC converters 40 can supply the electric power of the driving battery 20 connected to the secondary side to the auxiliary battery 30 and the auxiliary loads 100 connected to the primary side. At the time of supplying the electric power, the bidirectional DC-DC converters 40 boost the output voltage of the auxiliary battery 30, which is the input voltage on the primary side, to obtain the output voltage on the secondary side (during the step-up operation), and step down the voltage of the driving battery 20, which is the input voltage on the secondary side, to obtain the output voltage on the primary side (during the step-down operation). Instead of the bidirectional DC-DC converter 40, two unidirectional DC-DC converters may be provided in which the power transfer direction is reversed.

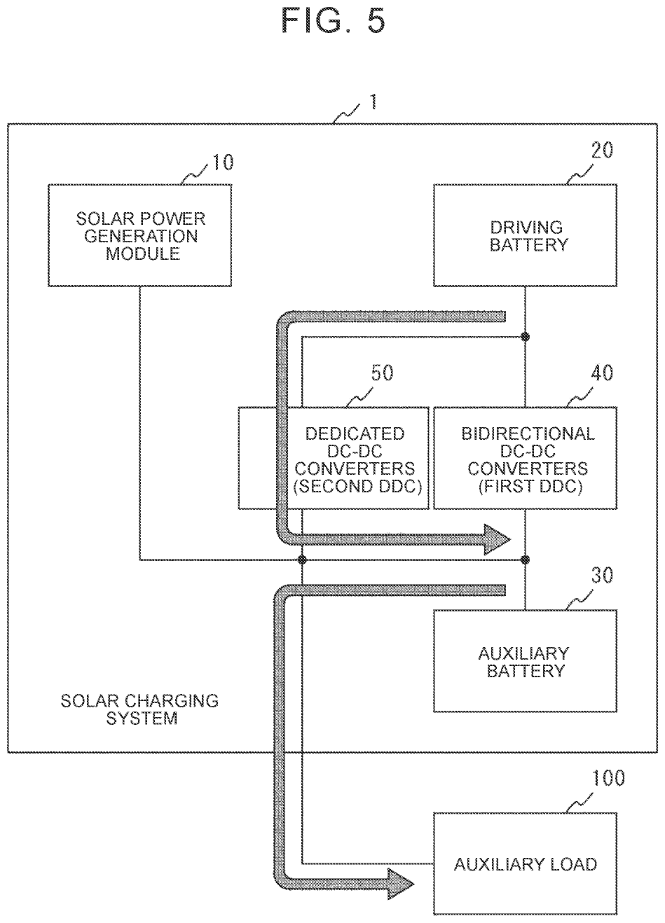

The dedicated DC-DC converter 50 is a power converter (second DC-DC converter) capable of converting the inputted power into a predetermined-voltage power and outputting the converted power. The dedicated DC-DC converters 50 have an input-side end connected to the driving battery 20, and an output-side end connected to the solar power generation module 10, the auxiliary battery 30, and the auxiliary loads 100. The dedicated DC-DC converters 50 can step down the electric power inputted from the driving battery 20 and supply the electric power to the auxiliary battery 30 (step-down operation). FIG. 5 shows an example of a power transfer path when the vehicle is parked and is supplied from the driving battery 20 to the auxiliary battery 30. The roles of the dedicated DC-DC converter 50 may be provided to the bidirectional DC-DC converter 40.

The bidirectional DC-DC converter 40 and the dedicated DC-DC converter 50 described above together with an electronic control unit (not shown) for controlling the operation of these DC-DC converters constitute a control unit for controlling the power transfer between the driving battery 20 and the auxiliary battery 30. The control executed by the control unit will be described later.

The auxiliary load 100 is a variety of auxiliary devices mounted on the vehicle. The auxiliary load 100 operates by receiving the power generated by the solar power generation module 10 and the power stored in the auxiliary battery 30. Examples of the auxiliary equipment include lighting equipment such as headlamps and indoor lamps, air conditioners such as heaters and air conditioners, and systems for autonomous driving and advanced driving support.

### Control

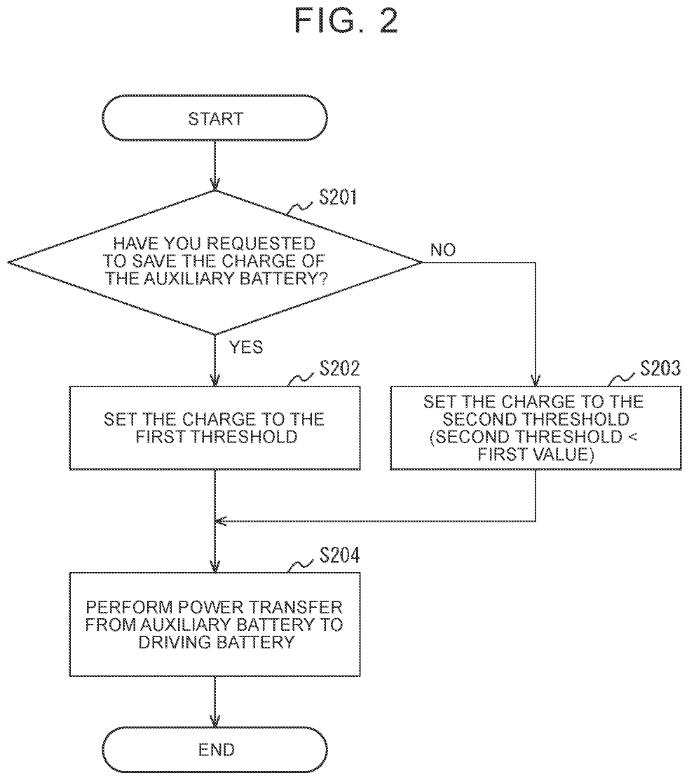

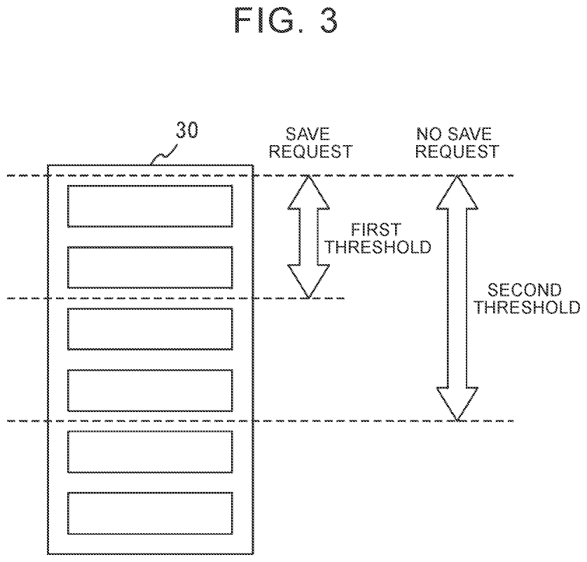

Next, the control performed by the solar charging system 1 according to the present embodiment will be described with further reference to FIGS. 2 and 3. FIG. 2 is a flowchart for explaining a procedure of charge control at the time of power transfer executed by the solar charging system 1. FIG. 3 is a diagram for explaining a change example of the remaining power amount of the auxiliary battery 30.

The charging control at the time of power transfer illustrated in FIG. 2 is started when the state of the vehicle is in a state of transferring power from the auxiliary battery 30 to the driving battery 20 (the charging state of the driving battery 20).

### S201

### S201

The solar charging system 1 determines whether or not there is a charge amount saving request for the auxiliary battery 30. The charge amount saving request of the auxiliary battery 30 is a request for limiting the charge amount (electric power amount) transferred from the auxiliary battery 30 to the driving battery 20 in order to charge the driving battery 20, and increasing the amount of electric power remaining in the auxiliary battery 30 after the electric power transfer process is performed as compared with a normal state.

An example of a situation in which the charge amount saving request of the auxiliary battery 30 is made is a case in which the solar power generation module 10 is unable to generate predetermined electric power. The predetermined electric power is, for example, electric power that does not exceed the generated electric power, such as ECU required for the charging process, even if the processing of charging the auxiliary battery 30 with the generated electric power of the solar panel is performed, and thus energy-efficiency is not deteriorated. The state of the vehicle in which the solar power generation module 10 cannot generate a predetermined electric power or is not expected to generate electric power can be exemplified by a case in which the time is a night period (such as a period from sunset to sunrise), a case in which the time is a weather such as cloudy weather or rainy weather, a case in which the vehicle is stored (parked, transported, or the like) for a predetermined period or longer in a state in which the amount of solar radiation is less than a predetermined amount (such as a state in which the vehicle is stopped in a garage with a roof), a case in which a component related to a charging process in the vehicle has failed, and the like. Alternatively, even when there is a predetermined instruction (such as an instruction not to use solar power generation) by the user of the vehicle or the like, the state of the vehicle in which the solar power generation module 10 cannot generate the predetermined electric power may be set.

When the solar charging system 1 determines that there is a charge saving demand for the auxiliary battery 30 (S201, Yes), the process proceeds to S202. On the other hand, when the solar charging system 1 determines that there is no charge saving demand for the auxiliary battery 30 (S201, No), the process proceeds to S203.

### S202

The solar charging system 1 sets (adjusts) a threshold value for controlling the amount of charge (amount of electric power) transferred from the auxiliary battery 30 to the driving battery 20 to the first threshold value. As shown in FIG. 3, the first threshold value is a threshold value for limiting the amount of charge transferred from the auxiliary battery 30 to the driving battery 20 to a smaller amount than in the normal state. When the amount of charge to be transferred from the auxiliary battery 30 to the driving battery 20 is set to the first threshold by the solar charging system 1, the process proceeds to S204.

### S203

The solar charging system 1 sets (adjusts) a threshold value for controlling the amount of charge (amount of electric power) transferred from the auxiliary battery 30 to the driving battery 20 to the second threshold value. As shown in FIG. 3, the second threshold value is a threshold value for performing, without limitation, the amount of charge transferred from the auxiliary battery 30 to the driving battery 20. Therefore, the second threshold value is set to a value smaller than the first threshold value described above. When the amount of charge to be transferred from the auxiliary battery 30 to the driving battery 20 is set to the second threshold by the solar charging system 1, the process proceeds to S204.

### S204

The solar charging system 1 performs power transfer from the auxiliary battery 30 to the driving battery 20. As a result, the driving battery 20 is charged by the electric energy of the auxiliary battery 30 determined by the first threshold value or the second threshold value. When power transfer from the auxiliary battery 30 to the driving battery 20 is executed by the solar charging system 1, the charge control at the time of this power transfer is ended.

### <Action, Effect>

As described above, according to the solar charging system 1 according to the embodiment of the present disclosure, when the electric power is transferred from the auxiliary battery 30 to the driving battery 20, when the time is in the nighttime zone, when the solar radiation amount is stored for a long period of time in a state in which it is not possible to secure, or when the components related to the charging process are malfunctioning, or when there is an instruction to stop the solar power generation by the user, the amount of electric power remaining in the auxiliary battery 30 is controlled (adjusted) to be smaller than the amount of electric power to be transferred from the auxiliary battery 30 to the driving battery 20 than in the normal state.

By this control, for example, when power generation in the solar charging system 1 cannot be expected, it is possible to reduce the chance that power needs to be transferred again from the driving battery 20 to the auxiliary battery 30 in order to prevent the auxiliary battery 30 from rising. Therefore, it is possible to suppress degradation in the life of components such as relays and electronic control units (ECU) (such as the number of ON/OFF).

Although an embodiment of the present disclosure has been described above, the present disclosure can be regarded as not only a solar charging system but also a charging control method at the time of power transfer, a control program of the method, a computer-readable non-transitory storage medium storing the control program, a vehicle equipped with a solar charging system, and the like.

The solar charging system of the present disclosure can be used in a vehicle or the like on which a solar panel is mounted.

What is claimed is:

1. A solar charging system mounted on a vehicle, the solar charging system comprising:
a power generation module using a solar panel;
an auxiliary battery for storing power generated by the power generation module;
a driving battery used for driving the vehicle; and
a control unit that is provided between the driving battery and the auxiliary battery and that controls power transfer between the driving battery and the auxiliary battery, wherein when a process of transferring power from the auxiliary battery to the driving battery is performed, the control unit changes an amount of power of the auxiliary battery to be transferred to the driving battery based on a state of the vehicle.

2. The solar charging system according to claim 1, wherein the control unit includes:
a first direct current-direct current converter that is able to supply the power of the auxiliary battery to the driving battery and that is able to supply power of the driving battery to the auxiliary battery; and
a second direct current-direct current converter for supplying the power of the driving battery to the auxiliary battery while the vehicle is being parked.

3. The solar charging system according to claim 1, wherein the control unit includes a direct current-direct current converter that is able to perform the power transfer bidirectionally between the auxiliary battery and the driving battery.

4. The solar charging system according to claim 2, wherein when the power generation module is not able to generate predetermined power as the state of the vehicle, the control unit reduces the amount of the power of the auxiliary battery to be transferred to the driving battery as compared with a case in which the power generation module is able to generate the predetermined power.

5. The solar charging system according to claim 4, wherein in at least one of a case in which a time period or weather is a time period or weather on which power generation is not able to be expected, a case in which the vehicle is stored for a predetermined period or longer in a state in which a solar radiation amount is less than a predetermined amount, a case in which a part related to a charging process in the vehicle is defective, and a case in which a predetermined instruction is given to the vehicle, as the state of the vehicle, the control unit reduces the amount of the power of the auxiliary battery to be transferred to the driving battery as compared with a case other than the at least one case.
